(19) United States
(12) Patent Application Publication
(10) Pub. No.: US 2026/0294192 A1
(43) Pub. Date: Oct. 1, 2026

(54) VACUUM HOSE EXTENSION ACCESSORY

(71) Applicant: VacBone LLC, Mt. View, HI (US)

(72) Inventor: John VUCKOVICH, Hilo, HI (US)

(21) Appl. No.: 19/634,804

(22) Filed: Mar. 31, 2026

Related U.S. Application Data
(60) Provisional application No. 63/781,579, filed on Apr. 1, 2025.

(51) Int. Cl. A47L 9/24; F16L 3/00; F16L 3/10; F16L 3/26

(52) U.S. Cl. CPC A47L 9/248; F16L 3/003; F16L 3/1041; F16L 3/26

(57) ABSTRACT

A hose brace, having a main body having a proximal end and a distal end, a dynamic body having a proximal end slidably arranged within the main body, the dynamic body having a distal end extending from the distal end of the main body, a first clamp and a second clamp extending from the main body and respectively arranged at the proximal and distal ends of the main body, and a third clamp extending from the dynamic body at a distal end thereof, wherein one or more of the first, second, or third clamps are adapted to frictionally secure a hose therein.

### CROSS-REFERENCE TO RELATED APPLICATIONS

This application claims priority, pursuant to 35 U.S.C. 119(e) to U.S. Application No. 63/781,579, filed on Apr. 1, 2025, which application is incorporated by reference herein in its entirety.

### FIELD

The present disclosure relates to a vacuum hose, specifically an accessory to be removably attached to a vacuum hose, or other type of hose.

### BACKGROUND

Vacuums typically come with a hose connected to a motor, where the motor drives a blower which, in turn, provides suction to the hose. One type of vacuum is a “shop vacuum”, typically found in workshops, garages or construction sites.

Vacuums which are designated as shop vacuums typically feature a stronger engine and a wider nozzle and hose. This configuration lets a user collect heavier, bulkier objects like nails and scraps of wood. Other common names that fall into this category include “workshop vac”, “job site vacuum” and “wet/dry vac”.

A shop vacuum is designed for heavy-duty cleaning tasks, such as cleaning up sawdust, drywall dust, and other debris commonly found in workshops and construction sites. It typically has a larger capacity and more powerful suction than a regular vacuum. Shop vacuums are also designed to handle wet messes, making them versatile for a wider range of cleaning tasks.

On the other hand, regular vacuums are designed for typical household cleaning, such as carpets, floors, and upholstery. They may not have the same level of durability or capacity as shop vacuums.

Regardless, many versions of vacuums have a hose, or extension hose, which directly connects to the motor and provides suction from one end to another, allowing debris to be vacuumed from the external end to an internal end leading into a collection container within the vacuum. Normally, these hoses comprise a corrugated wall and come in various lengths to accommodate a variety of tasks. These hoses are flexible and also are arranged to accept or accommodate different attachments at the external end. These attachments include extension tubes which increase the distance from the external end and the internal end of the hose, or various different types of nozzles which can attach to the external end of the hose or the external end of the extension tube attached to the hose.

However, there is a need for a device which may be removably attached to the hose which provides rigidity to the flexible hose enabling it to function as an extension tube, i.e., allowing a user to reach areas without having to use an extension tube, or to extend the reach of the external end in combination with at least one extension hose. In other words, there is a long-felt need for a device which functions to rigidize a section of a flexible hose.

### SUMMARY

Various embodiments of the present disclosure are generally related to an adjustable-length brace, which brace is arranged to removably accept a vacuum hose therein and along its respective terminating ends, thus providing rigidity to the attached hose along those respective terminating ends.

In some aspects, the present disclosure is generally related to an adjustable-length brace for removably securing a flexible hose, such as a vacuum hose. An embodiment may comprise a main body and a dynamic body slidably arranged within the main body, allowing for telescoping adjustment of the brace's overall length. The brace further includes a plurality of clamps, with at least one clamp on the main body and another on the dynamic body, which are configured to frictionally engage and hold a section of the flexible hose. A locking mechanism may be included to secure the dynamic body relative to the main body at a desired length, and a handle may be connected to the brace to facilitate user control.

A general object of an aspect of the disclosure is to provide a brace which removably accepts a flexible hose and provides rigidity to that hose along the brace's length. By temporarily rigidizing a section of the flexible hose, the brace allows the hose to function as an extension wand, enabling a user to reach areas that would otherwise be inaccessible without separate, fixed-length attachments.

A further object of an embodiment is to provide a brace with an adjustable length. The slidable arrangement of the dynamic body within the main body, in combination with a friction lock, allows a user to easily set and secure a custom length. This provides greater versatility than conventional fixed-length extension tubes and allows for compact storage when the brace is in a collapsed configuration.

Another object of an aspect of the disclosure is to provide a brace that can accommodate flexible hoses of various diameters. In some embodiments, the clamps are operatively arranged to removably accept clamp inserts. These inserts are configured to have a smaller internal diameter than the clamps themselves, allowing the brace to securely grip a wider range of commercially available hoses.

An additional object of an embodiment is to improve the ergonomics of using a vacuum. A handle, which may be rotatably connected to the proximal end of the brace, allows for a more comfortable and controlled grip. In other embodiments, a forearm support may be slidably connected to the main body. This support provides a counter-balance force on the user's forearm, which is particularly advantageous when the brace is in an extended configuration, thereby reducing user arm fatigue.

These and other objects, features, and advantages of the aspects of the present disclosure will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIGS. 1A-1C illustrate perspective views of a hose brace;

FIG. 2 illustrates an exploded view of the brace shown in FIGS. 1A-1C;

FIG. 3A is a cross-sectional view taken generally along line 3A-3A in FIG. 1A;

FIG. 3B is a cross-sectional view taken generally along line 3B-3B in FIG. 1B;

FIG. 4 generally illustrates the hose brace in use;

FIG. 5 illustrates an alternative embodiment of the hose brace shown in FIGS. 1A-1C; and,

FIG. 6 illustrates a portion of the brace shown in FIG. 5 which shows an alternative embodiment of the brace shown in FIG. 5.

### DETAILED DESCRIPTION

At the outset, it should be appreciated that like drawing numbers on different drawing views identify identical, or functionally similar, structural elements. It is to be understood that the claims are not limited to the disclosed aspects. Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood by one of ordinary skill in the art to which this disclosure pertains. The word “exemplary” is used herein to mean “serving as an example, instance, or illustration.” Any implementation described herein as “exemplary” is not necessarily to be construed as preferred or advantageous over other implementations. If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic.

It should be appreciated that the term “substantially” is synonymous with terms such as “nearly,” “about,” “approximately,” “around,” “bordering on,” and “close to,” and is intended to mean that the recited characteristic, parameter, or value need not be achieved exactly, but that deviations or variations are encompassed, including but not limited to, tolerances, measurement error, manufacturing tolerances, and adjustment. The term “approximately” is intended to mean values within ten percent of the specified value. It should be understood that use of “or” in the present application is with respect to a “non-exclusive” arrangement, unless stated otherwise, such that “A or B” may mean A, B, or both A and B. Furthermore, as used herein, “and/or” is intended to mean a grammatical conjunction used to indicate that one or more of the elements or conditions recited may be included or occur.

The terms “comprising,” “including,” and “having” are intended to be open-ended and mean that there may be additional elements other than the listed elements. The disclosure also expressly contemplates embodiments that “consist of” or “consist essentially of” the recited features.

It should be understood that any methods, devices or materials similar or equivalent to those described herein, or understood to one having skill in the art within, can be used in the practice or testing of the example embodiments. As such, those in the art will understand that any suitable material, now known or hereafter developed, may be used in forming the various embodiments described herein.

The specific dimensions, lengths, diameters, and shapes illustrated in the drawings and described in the specification are provided as exemplary and are not intended to be limiting. The disclosure contemplates that the components may be of any other suitable size, proportion, or shape appropriate for the intended application. For example, the overall length of the brace in its collapsed or extended state, and the diameter of the clamps and clamp inserts, may be varied to accommodate different standards or use cases, whether in imperial, metric, or other units of measure.

While the primary use case described herein relates to an accessory for a vacuum hose, particularly for a shop vacuum, this is intended to be exemplary and not limiting. The embodiments of the disclosure may be applied to any flexible conduit where temporary, adjustable rigidity is desired. Other potential applications include, but are not limited to, industrial dust or fume collection hoses, water hoses for gardening or pressure washing, flexible ducting for HVAC systems, pool cleaning hoses, or any other type of flexible tubing used in commercial, industrial, or residential settings.

It should be noted that the term “tube” is not intended to be restrictive on a particular shape, e.g., cylindrical, rather it should be interpreted to mean that a particular member, regardless of the shape, is hollow and has respective open ends.

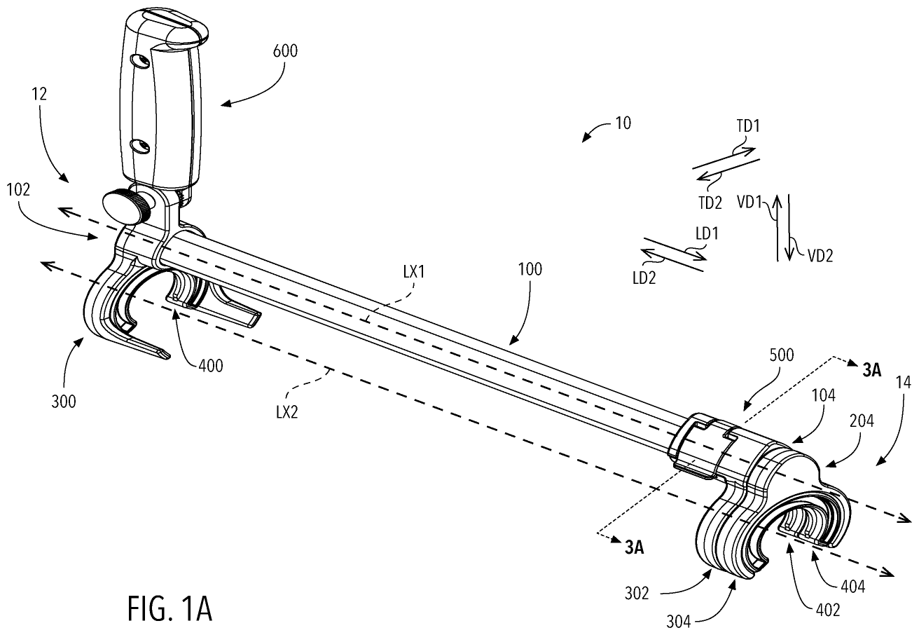

In references to FIGS. 1A through 1C, which generally illustrate perspective views of an example hose brace, e.g., hose brace 10. Specifically, FIG. 1A shows hose brace 10 in a collapsed configuration, FIG. 1B shows hose brace 10 expanding, and FIG. 1C generally shows hose brace 10 in an expanded configuration.

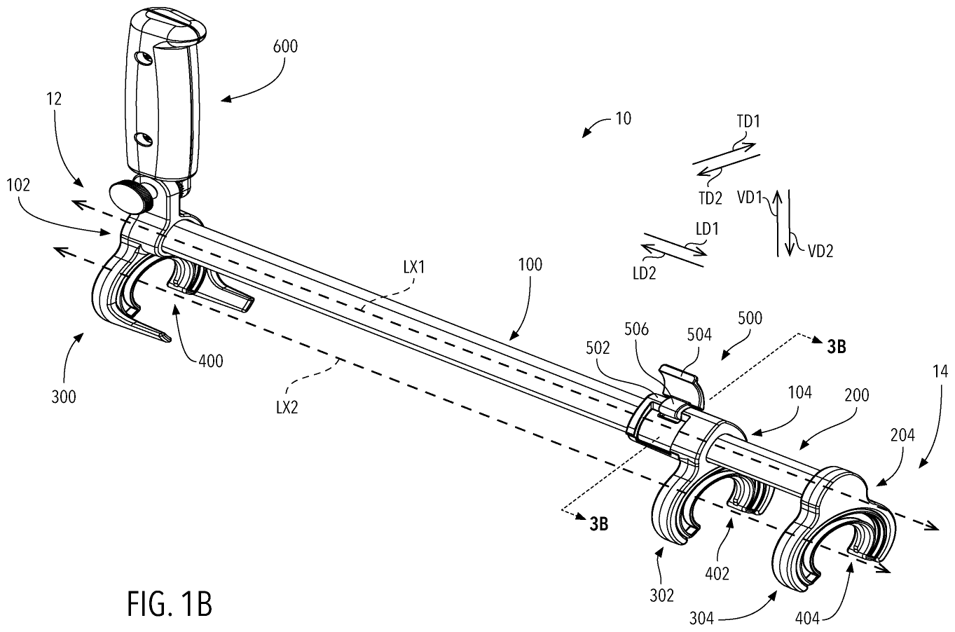

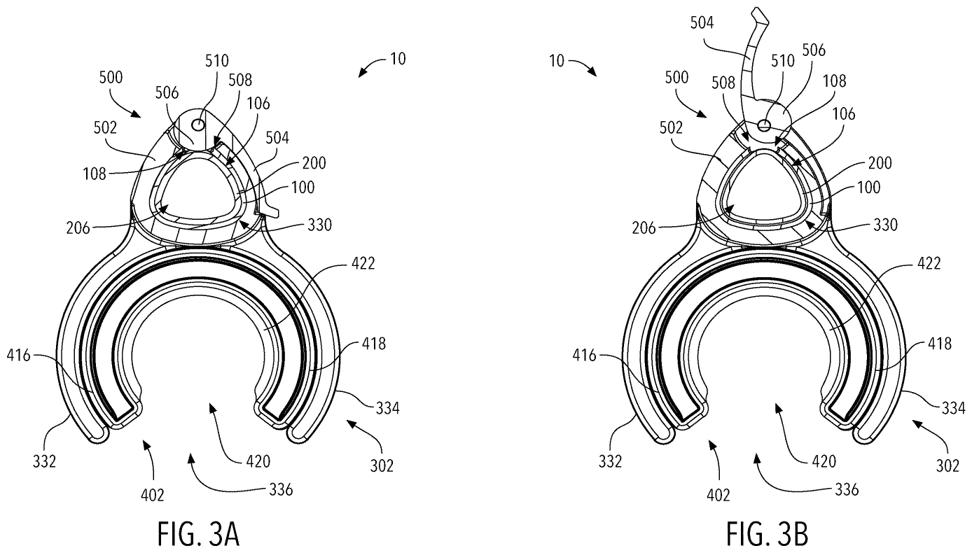

As shown, hose brace 10 includes proximal end 12 and distal end 14. Hose brace 10 includes main body 100 having proximal end 102 and distal end 104, dynamic body 200 having proximal end 202 (See FIG. 2) slidably arranged within main body 100 and distal end 204 extending from distal end 104 of main body 100. Main body 100 may be arranged to have first clamp 300 and second clamp 302 extending from and respectively arranged at proximal end 102 and distal end 104 thereof, respectively. Dynamic body 200 may have third clamp 304 extending from distal end 204 thereof. Generally, one or more of first clamp 300, second clamp 302, or third clamp 304 are designed to frictionally secure a hose, preferably a flexible vacuum hose, therein, generally shown in FIG. 4 and discussed further infra. It can be said that main body 100 and dynamic body 200 may be tubes. In a preferred embodiment, hose brace 10 includes handle 600 which is pivotably/rotatably arranged proximate proximal end 102 of main body 100.

Preferably, hose brace 10 also includes locking mechanism 500 disposed proximate distal end 104 of main body 100 and having second clamp 302 extending therefrom. Locking mechanism 500 generally includes body 502 having lever 504 rotatably attached thereto and cam 506 (a “friction body”) arranged on lever 504. Locking mechanism 500 allows dynamic arm 200 to translate within main body 100 (or be removed therefrom) when cam 506 of lever 504 is disengaged (See FIG. 1B), whereas locking mechanism also secures dynamic arm 200 within main body 100, either in a collapsed configuration (See FIG. 1A) or in an expanded configuration (See FIG. 1C, generally). In other words, dynamic body 200 is telescopingly arranged within main body 100.

It should be noted that “cam” is generally intended to mean a rotating piece that changes rotary motion into a linear motion of another piece being contacted by the rotating piece by rotation thereof.

In a preferred design, each of clamps 300, 302, and 304 have a respective clamp insert, e.g., clamp inserts 400, 402, and 404, which are removably arranged therein. As will be discussed further infra, clamp inserts 400, 402, and 404 allow the attachment space of clamps 300, 302, and 304 to be decreased, i.e., a smaller diameter, to accommodate different diameter hoses. In other words, clamp inserts 400, 402, and 404 all have respective attachment spaces which attachment spaces have a small diameter than that of the attachment spaces of clamps 300, 302, and 304.

Preferably, the respective ends of main body 100 are arranged about first longitudinal axis LX1. Likewise, the respective end of dynamic body 200 are also arranged about first longitudinal axis LX1. Thus, distal end 204 may be selectably positioned along longitudinal axis LX1, e.g., substantially abutting distal end 104 of main body 100 (See FIG. 1A), fully extended without removing dynamic body 200 from main body 100 and where locking mechanism 500 may still engage dynamic body 200 within main body 100 (See FIG. 1C), or somewhere in between (See FIG. 1B).

As discussed above, the attachment spaces of clamps 300, 302, 304 all have a center point which are substantially arranged about longitudinal axis LX2, thus, in a preferred embodiment, clamps 300, 302, and 304 and their respective attachment spaces are substantially collinear. Similarly, the attachment spaces of clamp inserts 400, 402, and 404 (when inserted into the respective clamps) all have a center point which are substantially arranged about longitudinal axis LX2, thus in a preferred embodiment, clamp inserts 400, 402, and 404 and their respective attachment spaces are substantially collinear.

FIG. 2 generally illustrates an exploded view of hose brace 10. In a preferred embodiment, hose brace 10 at least includes main body 100, dynamic body 200, locking mechanism 500 and clamps 300, 302, and 304. In some arrangements, hose brace 10 may further include handle 600 and clamp inserts 400, 402, and 404.

Main body 100 has proximal end 102 and distal end 104 which define openings to internal cavity 106. In other words, main body 100 may be a hollow tube. Slot 108 is disposed proximate distal end 104 and may be arranged to be open to the opening arranged within distal end 104 and internal cavity 106.

Dynamic body 200 has proximal end 202 and distal end 204 which define openings to internal cavity 206, although it should be noted that dynamic body 200 does not need to be configured substantially as a hollow tube but instead may be solid. In some arrangements, plug 208 may be inserted within internal cavity 206 proximate proximal end 202 such that a portion thereof extends from internal cavity 206 past proximal end 202.

As discussed above, hose brace 10 includes clamps 300, 302, and 304, where clamps 300 and 302 are secured to proximal end 102 and distal end 104 of main body 100, respectively, and clamp 304 is secured to distal end 204 of dynamic body 200.

Clamp 300 may comprise body 306 having first arm 310 and second arm 312 extending therefrom and also handle extension 322 extending therefrom. First arm 310 and second arm 312 substantially form a C-shaped clamp having an opening formed between the respective distal ends of arms 310 and 312, where an inner surface of the C-shape clamp defines attachment space 314 therein. The inner surface of the C-shaped clamp may also include protrusion 320 extending therefrom, which is preferably arcuate and runs along the entire of the inner surface from the respective distal ends of arms 310 and 312. In some arrangements, first extension 316 extends from the distal end of arm 310 in a direction towards distal end 104 of main body 100, and second extension 318 extends from the distal end of arm 312 in a direction towards distal end 104 of main body 100. As shown, handle extension 322 includes aperture 324 therein and plurality of teeth 326 (or protruding members) substantially circumscribing aperture 324 and protruding outwardly therefrom. Although not explicitly shown, body 306 also includes aperture 308 which is arranged to accept proximal end 102 of main body 100 fixedly or removably therein, thereby connecting clamp 300 within main body 100.

Clamp 302 may comprise body 328 and preferably is integral with locking mechanism 500, thus body 502 of locking mechanism and body 328 of clamp 302 are different portions of a singular body, which body includes aperture 330 extending therethrough. Body 328 includes first arm 332 and second arm 334 extending therefrom. First arm 332 and second arm 334 substantially form a second C-shaped clamp having an opening formed between the respective distal ends of arms 332 and 334, where an inner surface of the second C-shape clamp defines attachment space 336 therein. The inner surface of the second C-shaped clamp may also include protrusion 338 extending therefrom, which is preferably arcuate and runs along the entire of the inner surface from the respective distal ends of arms 332 and 334. Body 502 of locking mechanism includes lever 504 rotatably secured thereon via pin 510, which lever 504 may rotate about. As described supra, lever 504 includes cam 506 thereon which is further arranged to rest within aperture 508. Aperture 508 is in communication with aperture 330, thus cam 506 may protrude into aperture 330, and may protrude into internal space 106 through slot 108 when distal end 104 of main body 100 is secured within aperture 330 of bodies 328 and 502.

Clamp 304 may comprise body 340 having first arm 344 and second arm 346 extending therefrom. First arm 344 and second arm 346 substantially form a C-shaped clamp having an opening formed between the respective distal ends of arms 344 and 346, where an inner surface of the C-shape clamp defines attachment space 348 therein. The inner surface of the C-shaped clamp may also include protrusion 350 extending therefrom, which is preferably arcuate and runs along the entire of the inner surface from the respective distal ends of arms 344 and 346. Body 340 includes aperture 342 therein which is arranged to accept distal end 204 of dynamic arm 200 therein, fixedly or removably, thereby connecting clamp 304 to dynamic arm 200.

In a preferred embodiment, clamp inserts 400, 402, and 404 are substantially identical, each of which having first arms 406, 416, and 426 and second arms 408, 418, and 428, which respective pairs of arms form a C-shaped clamp in each of clamp inserts 400, 402, and 404 and also form openings between the respective distal ends of the respective pair of arms, where an inner surface of each C-shaped clamp of clamp inserts 400, 402, and 404 defines attachment spaces 410, 420, 430, respectively. Further, each inner surfaces of each C-shaped clamp of clamp inserts 400, 402, and 404 includes a protrusion extending therefrom, protrusions, 412, 422, and 432, respectively, which protrusions are preferably arcuate and runs along the entire inner surface of each C-shaped clamp. Additionally, each outer surface of each C-shaped clamp of clamp inserts 400, 402, and 404 includes a channel arranged therein, channels 414, 424, and 434, respectively. Channels 414, 424, and 434 are arranged to accept protrusions 320, 338, and 350 therein when clamp inserts 404, 402, and 404 are frictionally inserted within attachment spaces 314, 336, and 348 of clamps 300, 302, and 304, respectively.

The clamp inserts are arranged to be frictionally secured within the attachment spaces of the clamps. For example and in reference to first clamp 300 and first clamp insert 400, arms 310 and 312 of clamp 300 flex radially outward from a center point of attachment space 314 when the outer surface of clamp insert 400 is pressed onto the distal ends of arms 310 and 312, thus enlarging the space therebetween until clamp insert 400 is within attachment space 314 and the inner surface arms 310 and 312 may then rest on the outer surface of clamp insert 400, thus protrusion 320 is seated within channel 414 of the outer surface of clamp insert 400. While arms 310 and 312 prevent vertical and/or transverse movement of clamp insert 400 within attachment space 314, protrusion 320 within channel 414 at least substantially limits longitudinal movement. Thus, to remove clamp insert 400 from attachment space 314 of clamp 300, clamp insert 400 must be pulled in a downward direction, i.e., pulled out of the space formed between the distal ends of arms 310 and 312, thus flexing arms 310 and 312 radially outward until clamp insert 400 is released therefrom.

As discussed supra and in reference to FIG. 2, handle extension 322 includes aperture 324 therein and plurality of teeth 326 substantially circumscribing aperture 324 and protruding outwardly therefrom. Handle 600 is arranged to be rotatably secured to handle extension 322. In some embodiments, handle may comprise first portion 602 having distal extension 604 with aperture 606 and plurality of teeth 608 (or protrusions) substantially circumscribing aperture 606 and protruding outwardly therefrom, and second portion 610, where first portion 602 and second portion 610 may be connected via one or more of fasteners 612, or alternatively, the first and second portions of the handle may be integrally formed. To connect handle 600 to handle extension 322 of clamp 300, apertures 324 and 606 are aligned and the respective pluralities of teeth 326 and 608 mesh together, which prevent rotation once tightening screw 616 is secured in apertures 324 and 606 and tighten via nut 614. Thus, screw 616 and nut 614 may be loosened such that the pluralities of teeth 326 and 608 may be disengaged to allow handle 600 to be pivoted at a desirable angle, i.e., substantially perpendicular to main body 100 as shown in FIGS. 1A-1C, or pivoted to another angle, or removed entirely. In other embodiments, tightening screw 616a may be used instead of tightening screw 616. The difference between screws 616a and 616, is that screw 616a has a star-like configuration as opposed to a rounded or circular configuration. The star-like configuration of screw 616a is designed to allow a user to apply additional force when tightening screw 616a due to the protruding portions that form the star-like configuration, making tightening or loosening the screw in a manual fashion, easier. Lastly, it should be appreciated that the tightening screw may take various other forms and configurations, such as a thumb screw, so long as at least 90-degree pivoting of handle 600 may be accomplished.

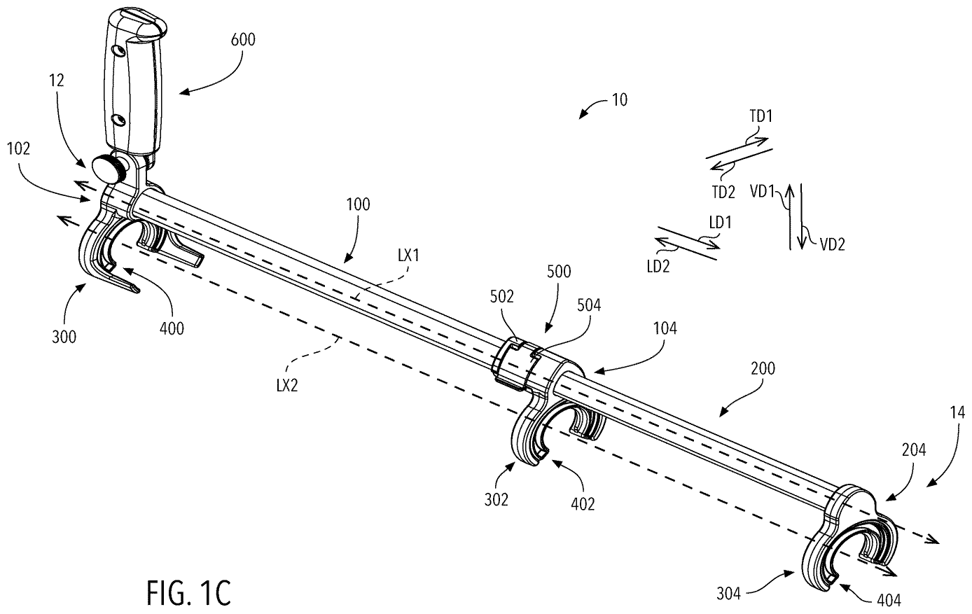

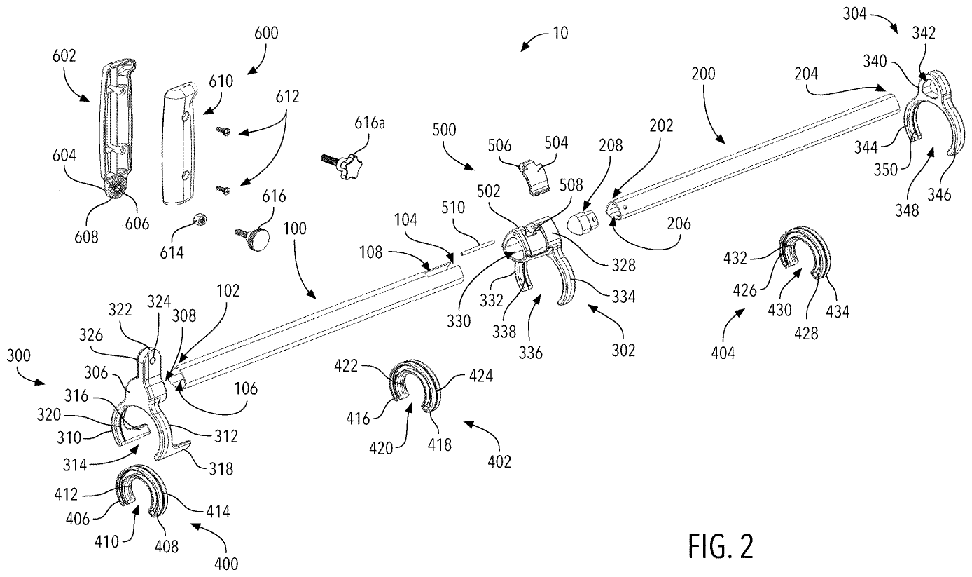

The following description should be taken in view of the aforementioned figures and specifically, FIGS. 3A and 3B, which are cross-sectionals taken generally along line 3A-3A in FIG. 1A and line 3B-3B in FIG. 1B, respectively. As described supra, the configuration of hose brace 10 shown in FIG. 3A, particularly the configuration of locking mechanism 500, is a locked configuration, whereas FIG. 3B shows an unlocked configuration of the same. Slot 108 of main body 100 and aperture 508 of body 502 of locking mechanism 500 are in communication, thereby providing an opening to dynamic body 200 arranged within internal cavity 106 of main body 100, where main body 100 is arranged within aperture 330 of at least one of bodies 328 and 502. Thus, cam 506 of lever 504 may be at least partially seated within, preferably a portion thereof extending through, slot 108 and aperture 508. In other words, when lever 504 is rotatably seated within body 502, i.e., resting thereon or therein, a portion of cam 506 extends into internal cavity 106, thus abutting an outer surface of dynamic body 200 and preferably, moving dynamic body 200 such that at least a portion its outer surface forcibly abuts at least a portion of the inner surface of main body 100, thereby creating a friction-lock as shown in FIG. 3A. As such, when lever 504 is not rotatably seated within body 502, the portion of cam 506 is rotatably removed from aperture 508 and slot 108, i.e., no longer within internal cavity 106, thus no longer contacting the outer surface of dynamic body 200, there is a space between the outer surface of dynamic body 200 and the inner surface of main body 100 allowing dynamic body 200 to translate within internal cavity 106 as generally illustrated in FIG. 3B.

In particular reference to FIG. 4, along with the aforementioned figures, hose brace 1 is shown in an expanded configuration and with hose 20 removably connected thereto via one or more of clamps 300, 302, 304 or clamp inserts 400, 402, or 403. In typical use, hose 20 would be a flexible hose. Preferably, hose 20 is snappingly inserted into one or more of attachment spaces 314, 336, 348, 410, 420, or 430 (See FIG. 2, attachment spaces 314, 348, 410 and 430), thus straightening hose along longitudinal axis LX2, where otherwise, generally illustrated proximate proximal end 22 of hose 20, hose 20 is flexible. In other words, hose brace 10 provides rigidity to hose 20 along longitudinal axis LX2 such that hose brace 10 via handle 600 may be held by a user to maneuver distal end 24 of hose 20 where attachment 30 of hose 20 is connected, thus extending the reach of engaged hose 20 from proximal end 12 to distal end 14 of hose brace 10, where disengage hose 20 is flexible and is not supported to remain lengthened about longitudinal axis LX2.

It should be appreciated that hose 20 may be frictionally secured to hose brace 10 by one or more of attachment spaces 314, 336, or 348 of clamps 300, 302, and 304, respectively, or attachment spaces 410, 420, or 430 of clamp inserts 400, 402, and 404, respectively, depending on the particular diameter of hose 20. In other words, either clamps 300, 302, and 304, or the combination of clamps 300, 302, and 304 with clamp inserts 400, 402, 404, rigidize a section of hose 20 releasably held therein.

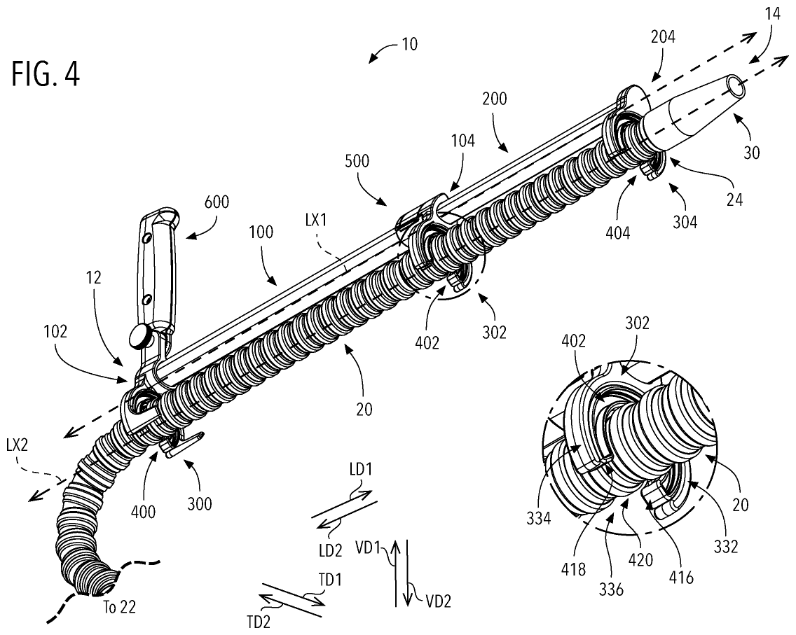

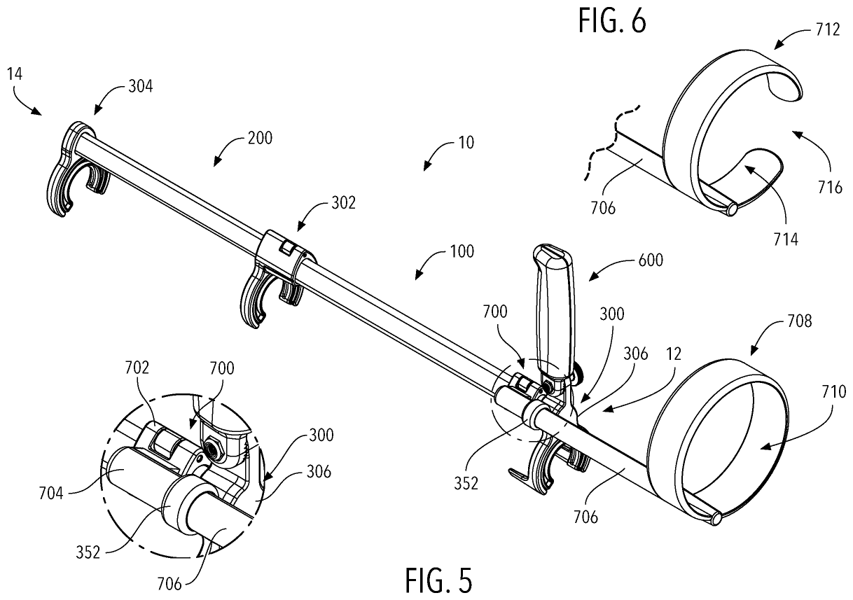

FIGS. 5 and 6 which generally illustrate an alternative embodiment of hose brace 10. In some arrangements, hose brace 10 may include a forearm support extending from proximal end 12. Crutch connector 700 may be slidably or telescopically arranged on main body 100, where crutch connector 700 may have a similar configuration to body 502, thereby allowing crutch connector 700 be selectably locked at a specific location along main body 100 between clamps 300 and 302. In one possible configuration, extension 704 extends from or protrudes from body 702 of crutch connector 700, where shaft 706 extends from extension 704 in the direction of proximal end 12 of brace 10. In one arrangement, support ring 352 protrudes from body 306 of clamp 300, where shaft 706 is seated therein and may slide therein as crutch connector 700 is slid along main body 100. At a terminating end of shaft 706 is forearm cuff 708, which may be configured as an annual ring having aperture 710 therein, or alternatively, as shown in FIG. 6, as forearm cuff 712, which is arcuate, or substantially C-shaped with space 714 therein and opening 716. In either configuration, a user places their arm in one of forearm supports 708 or 712 when holding handle 600, thus providing a counter-balance-like or opposing force on the users forearm within one of forearm supports 708 or 712 when distal end 14 is in an expanded configuration, thusly reducing arm fatigue of a user.

### EXAMPLES

The following provides a detailed description of certain exemplary embodiments of the present disclosure. It is to be understood that these embodiments are provided for illustrative purposes and are not to be construed as limiting the scope of the disclosure in any way.

In some aspects, a hose brace embodiment may comprise a main body having a proximal end and a distal end. A dynamic body, also having a proximal end and a distal end, can be slidably arranged within the main body such that its distal end extends from the distal end of the main body. This arrangement allows the dynamic body to translate within the main body, thereby providing an adjustable overall length for the brace. The brace may further include a plurality of clamps configured to frictionally secure a hose therein. For instance, a first clamp and a second clamp may extend from the main body, respectively arranged at its proximal and distal ends, while a third clamp may extend from the distal end of the dynamic body. This configuration allows for the adjustable distance between the second clamp and the third clamp to be modified. In some embodiments, the brace may comprise only two clamps, such as a first clamp on the main body and a second clamp on the dynamic body. Furthermore, any of the foregoing embodiments may include a handle rotatably connected to the proximal end of the main body to facilitate user manipulation. In other aspects, a friction lock can be arranged proximate the distal end of the main body. This friction lock may include a pivotably attached friction body, such as a cam, which is adapted to apply a force onto the dynamic body when the lock is engaged to prevent translation, and to release said force when disengaged to allow the dynamic body to slide freely within the main body.

In some embodiments, each of the clamps may comprise a substantially C-shaped body that forms an attachment space for a hose. The C-shaped body may be defined by a first arm and a second arm which form an opening therebetween, allowing a hose to be snapped into place. To enhance grip, especially on a corrugated hose, each C-shaped body of the clamps may include a protruding member extending radially into the attachment space. To accommodate hoses of various diameters, the clamps can be operatively arranged to removably accept a clamp insert. In such aspects, the clamp insert may also comprise a substantially C-shaped body forming its own attachment space, where the attachment space of the clamp has a first diameter and the attachment space of the clamp insert has a second diameter that is smaller than the first. Furthermore, the aforementioned protruding member of a clamp can be arranged to seat within a corresponding channel on an outer surface of the clamp insert, thereby securing the insert within the clamp. In any of the foregoing embodiments, the first clamp may also include extension fingers extending from its arms to further guide or secure a hose. In another aspect, any of the described brace embodiments may further comprise a forearm support. This support may be slidably connected to the main body and include a body, a shaft extending from the body, and a forearm cuff arranged at a terminating end of the shaft. This feature provides an additional point of contact for the user, offering enhanced stability and reducing arm fatigue, particularly when the brace is in an extended configuration.

It will be appreciated that the embodiments of the present disclosure are merely exemplary and that various features and functions, or alternatives thereof, may be desirably combined into many other different systems or applications. Thusly, various alternatives, combinations, and omissions of specific components, as well as presently unforeseen or unanticipated modifications, variations, or improvements therein may be subsequently made by those skilled in the art, and are all intended to be encompassed by the appended claims.

### LIST OF REFERENCE NUMERALS

10 Brace
12 Proximal end
14 Distal end
20 Hose
22 Proximal end
24 Distal end
30 Attachment
100 Main body
102 Proximal end
104 Distal end
106 Internal cavity
108 Slot
200 Dynamic body
202 Proximal end
204 Distal end
206 Internal cavity
208 Plug
300 First clamp
302 Second clamp
304 Third clamp
306 Body
308 Aperture
310 First arm
312 Second arm
314 Attachment space
316 First extension
318 Second extension
320 Protrusion
322 Handle extension
324 Aperture
326 Plurality of teeth
328 Body
330 Aperture
332 First arm
334 Second arm
336 Attachment space
338 Protrusion
340 Body
342 Aperture
344 First arm
346 Second arm
348 Attachment space
350 Protrusion
352 Support ring
400 First clamp insert
402 Second clamp insert
404 Third clamp insert
406 First arm
408 Second arm
410 Attachment space
412 Protrusion
414 Channel
416 First arm
418 Second arm
420 Attachment space
422 Protrusion
424 Channel
426 First arm
428 Second arm
430 Attachment space
432 Protrusion
434 Channel
500 Locking mechanism
502 Body
504 Lever
506 Cam
508 Aperture
510 Pin
600 Handle
602 First portion
604 Distal extension
606 Aperture
608 Plurality of teeth
610 Second portion
612 Fasteners
614 Nut
616 Tightening screw
616a Tightening screw
700 Crutch connector
702 Body
704 Extension
706 Shaft
708 Forearm cuff
710 Aperture
712 Forearm cuff
714 Space
716 Opening
LD1-LD2 Longitudinal direction
TD1-TD2 Transverse direction
VD1-VD2 Vertical direction
LX1 First longitudinal axis
LX2 Second longitudinal axis

What is claimed is:

1. A hose brace, comprising:
a main body having a proximal end and a distal end;
a dynamic body having a proximal end slidably arranged within the main body, the dynamic body having a distal end extending from the distal end of the main body;
a first clamp and a second clamp extending from the main body and respectively arranged at the proximal and distal ends of the main body; and,
a third clamp extending from the dynamic body at a distal end thereof,
wherein one or more of the first, second, or third clamps are adapted to frictionally secure a hose therein.

2. The hose brace recited in claim 1, wherein the dynamic body is arranged to translate within the main body, thereby providing an adjustable distance between the second clamp and the third clamp.

3. The hose brace recited in claim 1 further comprising a handle rotatably connected to the proximal end of the main body.

4. The hose brace recited in claim 1 further comprising a friction lock arranged proximate the distal end of the main body, the friction lock having a pivotably attached friction body which is adapted to apply a force onto the dynamic body within the main body when the friction lock is engaged and release the force when the friction lock is disengaged thereby allowing the dynamic body to translate within the main body.

5. The hose brace recited in claim 1, wherein each of the clamps comprises a substantially C-shaped body forming an attachment space therein, the C-shaped body having a first arm and a second arm which arms define an opening therebetween.

6. The hose brace recited in claim 5, wherein each C-shaped body of the clamps includes a protruding member extending radially into the attachment space.

7. The hose braced recited in claim 6, wherein each of the clamps is operatively arranged to removably accept a clamp insert therein, the clamp insert comprising a substantially C-shaped body forming an attachment space therein, the C-shaped body of the clamp insert having a first arm and a second arm, which arms define an opening therebetween, the clamp having a channel arranged on an outer surface of the C-shaped body, wherein the protruding member of each C-shaped body of the clamps is arranged to be at least partially seated within the channel of the clamp insert when the clamp insert is within the attachment space of one of the clamps.

8. The hose brace recited in claim 7, wherein the attachment space of each of the clamps has a first diameter and the attachment space of the clamp insert has a second diameter, the first diameter greater than the second diameter.

9. The hose brace recited in claim 5, wherein the first clamp includes extension fingers extending from each of the arms proximate the attachment space.

10. A hose brace, comprising:
a main body having a proximal end and a distal end;
a dynamic body having a proximal end slidably arranged within the main body, the dynamic body having a distal end extending from the distal end of the main body;
a first clamp and a second clamp extending from the main body and respectively arranged at the proximal and distal ends of the main body;
a third clamp extending from the dynamic body at a distal end thereof;
a friction lock arranged proximate the distal end of the main body, the friction lock having a pivotably attached friction body which is adapted to apply a force onto the dynamic body within the main body when the friction lock is engaged and release the force when the friction lock is disengaged thereby allowing the dynamic body to translate within the main body; and,
a handle rotatably connected to the proximal end of the main body;
wherein one or more of the first, second, or third clamps are adapted to frictionally secure a hose therein.

11. The hose brace recited in claim 10, wherein each of the clamps includes an attachment space therein, the attachment space having a first diameter, wherein the attachment space of each of the clamps is operatively arranged to removably accept a clamp insert therein, the clamp insert having an attachment space therein, the attachment space of the clamp insert having a second diameter, wherein the first diameter is greater than the second diameter.

12. A hose brace, comprising:
a main body having a proximal end and a distal end;
a dynamic body having a proximal end slidably arranged within the main body, the dynamic body having a distal end extending from the distal end of the main body;
a first clamp extending from the main body and respectively arranged at the proximal end of the main body; and,
a second clamp extending from the dynamic body at a distal end thereof,
wherein one or more of the first or second clamps are adapted to frictionally secure a hose therein.

13. The hose brace recited in claim 12 further comprising:
a third clamp extending from the main body and respectively arranged at the distal end of the main body,
wherein one or more of the first, second, or third clamps are adapted to frictionally secure a hose therein.

14. The hose brace recited in claim 12, wherein the dynamic body is arranged to translate within the main body, thereby providing an adjustable distance between the first clamp and the second clamp.

15. The hose brace recited in claim 13, wherein the dynamic body is arranged to translate within the main body, thereby providing an adjustable distance between the second clamp and the third clamp.

16. The hose brace recited in claim 12 further comprising a handle rotatably connected to the proximal end of the main body.

17. The hose brace recited in claim 12 further comprising a friction lock arranged proximate the distal end of the main body, the friction lock having a pivotably attached friction body which is adapted to apply a force onto the dynamic body within the main body when the friction lock is engaged and release the force when the friction lock is disengaged thereby allowing the dynamic body to translate within the main body.

18. The hose brace recited in claim 12 further comprising a forearm support slidably connected to the main body and extending past the proximal end thereof.

19. The hose braced recited in claim 18, wherein the forearm support further comprises:
a body slidably arranged on the main body;
a shaft extending from the body of the forearm support; and,
a forearm cuff arranged proximate a terminating end of the shaft opposite the body of the forearm support.
